(19) United States
(12) Patent Application Publication
(10) Pub. No.: US 2023/0313694 A1
(43) Pub. Date: Oct. 5, 2023

(54) TURBINE NOZZLE DEVICE

(71) Applicant: HONDA MOTOR CO., LTD., Tokyo (JP)

(72) Inventor: Naoki KUNO, Saitama (JP)

(21) Appl. No.: 18/186,305

(22) Filed: Mar. 20, 2023

(30) Foreign Application Priority Data
Mar. 29, 2022 (JP) 2022-054120

(51) Int. Cl. F01D 9/04; F01D 5/18

(52) U.S. Cl. CPC F01D 9/041; F01D 5/18; F05D 2240/128; F05D 2260/20

(57) ABSTRACT

A turbine nozzle device (100) including a plurality of stator vanes (90), a flow path (92) being defined between a leading edge part of each stator vane and a trailing edge part of the adjoining stator vane, wherein the flow path includes an inlet (92A), an outlet (92B) and a throat (92C) located between the upstream part and the downstream part and narrower than the inlet and the outlet, and a surface of the trailing edge part of each stator vane that faces the flow path includes a steeply inclined part (91) which is located downstream of the throat and more steeply inclined than a part of the surface upstream of the throat.

### TECHNICAL FIELD

The present invention relates to a turbine nozzle device.

### BACKGROUND ART

In recent years, in order to ensure sustainable and advanced access to energy for more people, research and development related to improving fuel efficiency, which contributes to energy efficiency, has been extended to the field of gas turbine equipment.

Research efforts to improve fuel efficiency in gas turbine equipment include the improvement in the design of the turbine nozzle device that impinges a medium such as combustion gas against the turbine rotor.

Conventionally known turbine nozzle devices typically include a row of stator vanes each having an aerofoil cross section with a sharply tapered trailing edge. See JP2018-145811A and JP2018-145812A, for instance. In the turbine nozzle device disclosed in JPH6-280503A, the trailing edge of each stator vane is curved and sharply tapered, the curvature thereof progressively increasing from a part immediately downstream of a throat to the trailing edge part. In the turbine nozzle device disclosed in JP2019-94779A, a throat is defined between the trailing edge of each stator vane and the opposing part of the negative pressure surface of the adjacent stator vane formed as a curved surface, and the trailing edge of each stator vane is sharply tapered.

In turbine nozzles where the cross sectional area of each flow passage continuously decreases to the outlet (trailing edge), as the Mach number increases, the interferences of shock waves cause an undue increase in the pressure loss. The pressure loss is particularly great when the Mach number is about one. In turbine nozzles where the flow path includes a throat, the pressure loss may be reduced, but the trailing edge of the stator vane that defines the outlet of the flow path is required to be so thin that various problems associated with manufacture, heat resistance and mechanical strength arise, and this makes a practical design of a turbine nozzle device very difficult.

### SUMMARY OF THE INVENTION

In view of such a problem of the prior art, a primary object of the present invention is to provide a turbine nozzle device which allows the velocity of the medium at the nozzle outlet to be increased without causing any undue increase in the pressure loss, and contributes to the improvement in energy efficiency.

To achieve such an object, the present invention provides a turbine nozzle device (100) including a plurality of stator vanes (90), a flow path (92) being defined between a leading edge part of each stator vane and a trailing edge part of the adjoining stator vane, wherein the flow path includes an inlet (92A), an outlet (92B) and a throat (92C) located between the inlet and the outlet and narrower than the inlet and the outlet, and

a surface of the trailing edge part of each stator vane that faces the flow path includes a steeply inclined part (91) which is located downstream of the throat and more steeply inclined than a part of the surface upstream of the throat so as to form a widening part of the flow path extending from the throat or a point adjacent to the throat to the outlet.

Thereby, the pressure loss of the medium in the turbine nozzle device can be minimized, and the velocity of the medium at the outlet of the nozzle device can be maximized.

Preferably, an angle (θ1) formed by a tangent line at a start point of the steeply inclined part and a tangent line at an end point of the steeply inclined part is 10 to 30 degrees.

Thereby, occurrence of flow separation at the steeply inclined part can be avoided, and generation of shock wave can be avoided.

Preferably, the steeply inclined part has a length related to a width of the flow path at the throat as given by 1 ≦ (D1/L) ≦ 4, where D1 is the width of the flow path at the throat, and L is the length of the steeply inclined part.

Thereby, the pressure loss of the medium in the turbine nozzle device can be minimized, and the flow velocity of the medium at the nozzle outlet can be made supersonic.

Preferably, a surface of the trailing edge part facing away from the steeply inclined part includes an opposite inclined part (93) which is inclined in a same direction as the steeply inclined part.

Thereby, the thickness of the trailing part of the stator vane downstream of the throat can be given with an adequate thickness so that the mechanical strength of the stator vane is ensured.

Preferably, an angle (θ2) formed by a tangent line at a start point of the opposite inclined part and a tangent line at an end point of the opposite inclined part is 0 to 10 degrees.

Thereby, the thickness of the part of the stator vane downstream of the throat can be given with an adequate thickness so that the mechanical strength of the stator vane is ensured.

Preferably, a surface of the trailing edge part facing away from the steeply inclined part includes an opposite inclined part (93) which is inclined in an opposite direction to the steeply inclined part.

In this case, an angle (θ2) formed by a tangent line at a start point of the opposite inclined part and a tangent line at an end point of the opposite inclined part is from — 5 to 0 degrees.

Thereby, the thickness of the part of the stator vane at and upstream of the throat is prevented from becoming excessively great.

Preferably, each stator vane is internally provided with a cooling passage (94) extending along the flow path and a lengthwise direction of the stator vane.

Thereby, the stator vane is prevented from being excessively heated.

The present invention thus provides a turbine nozzle device which allows the velocity of the medium at the nozzle outlet to be increased without causing any undue increase in the pressure loss, and contributes to the improvement in energy efficiency.

### BRIEF DESCRIPTION OF THE DRAWING(S)

FIG. 1 is a sectional view of a gas turbine power generator system to which the present invention is applied;

FIG. 2 is a diagram of a turbine nozzle device according to a first embodiment of the present invention;

FIG. 3 is a diagram showing a modification of the stator vanes for the turbine nozzle device; and

FIG. 4 is a view similar to FIG. 2 showing a turbine nozzle device according to a second embodiment of the present invention.

### DESCRIPTION OF THE PREFERRED EMBODIMENT(S)

Preferred embodiments of the present invention will be described in the following with reference to the appended drawings.

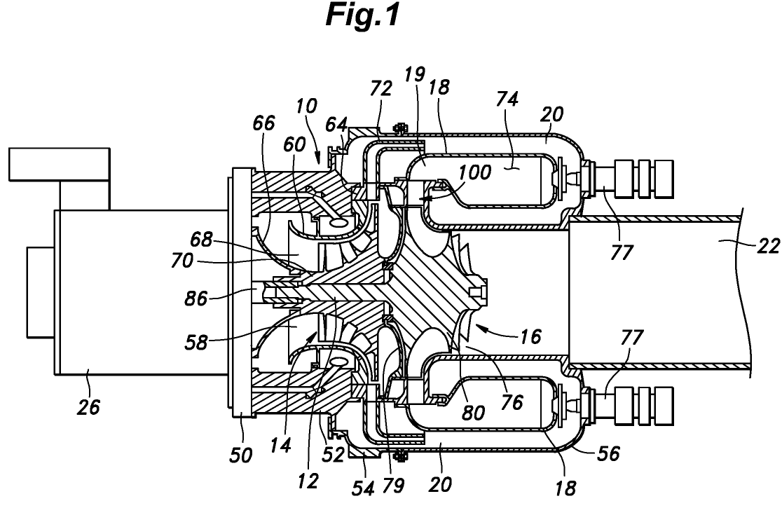

FIG. 1 shows a gas turbine power generator system 10 including a gas turbine engine fitted with a nozzle device 100 according to first embodiment of the present invention. The gas turbine power generator system 10 includes a radial compressor 14 and a radial turbine 16 coaxially connected to each other by a rotary shaft 12, and a generator 26 connected to the rotary shaft 12.

The gas turbine power generator system 10 is provided with a front end plate 50, a front housing 52, an intermediate housing 54, and a rear housing 56 that are axially connected to each other in that order in a substantially cylindrical configuration.

The radial compressor 14 includes a substantially cylindrical compressor housing 60 substantially received in the front housing 52, and attached thereto to internally define a compressor chamber 58. A compressor rotor 70 is attached to the rotary shaft 12, and is rotatably positioned in the compressor chamber 58. A conical air intake guide member 66 is provided concentrically to the compressor housing 60 in a front end part of the compressor housing 60 to jointly define an air intake 68. The front end of the air intake guide member 66 is attached to the front end plate 50. A diffuser 72 is connected to the rear end part of the compressor housing 60 via a diffuser fixing member 64. The compressor rotor 70 is rotationally driven by the rotary shaft 12 which is the output shaft of the radial turbine 16.

Air (outside air) is introduced from the air intake 68 of the radial compressor 14, and compressed and pressurized by the compressor rotor 70 to be ejected from the radial compressor 14 via the diffuser 72.

A plurality of combustors 18 are provided along the inner periphery of the rear housing 56 circumferentially around the central axis of the rotary shaft 12. The rear housing 56 includes a part defining compressed air passages 20 that direct the compressed air from the diffuser 72 to the different combustors 18. Each combustor 18 defines a combustion chamber 74 therein, and a fuel injection nozzle 77 is attached to the rear end of the combustor 18. The fuel injection nozzle 77 injects fuel into the combustion chamber 74.

In each combustion chamber 74, the fuel injected into the combustion chamber 74 by the fuel injection nozzle 77 is mixed with the compressed air supplied by the radial compressor 14, and combusted to generate high-pressure combustion gas.

The radial turbine 16 is provided with a turbine chamber 76 defined by a radially inner part of the rear housing 56. The turbine chamber 76 is separated from the compressor chamber 58 by a partition wall member 79. The rotary shaft 12 is integrally fitted with a turbine rotor 80 to be rotatably situated in the turbine chamber 76.

The front end (downstream end) of each combustor 18 is provided with a gas outlet 19, and the combustion gas emitted from the combustor 18 is forwarded to an annular turbine nozzle device 100 that surrounds the turbine rotor 80 so as to radially impinge the combustion gas onto the turbine rotor 80. The turbine rotor 80 is rotationally driven by the combustion gas injected from turbine nozzle device 100. The combustion gas that has rotationally driven the turbine rotor 80 is discharged to the atmosphere from an exhaust gas passage 22 connected to the rear end of the rear housing 56 as exhaust gas.

A rotor shaft 86 of the generator 26 is connected to the rotary shaft 12 so that the generator 26 is rotationally driven by the rotary shaft 12 of the radial turbine 16 to generate power.

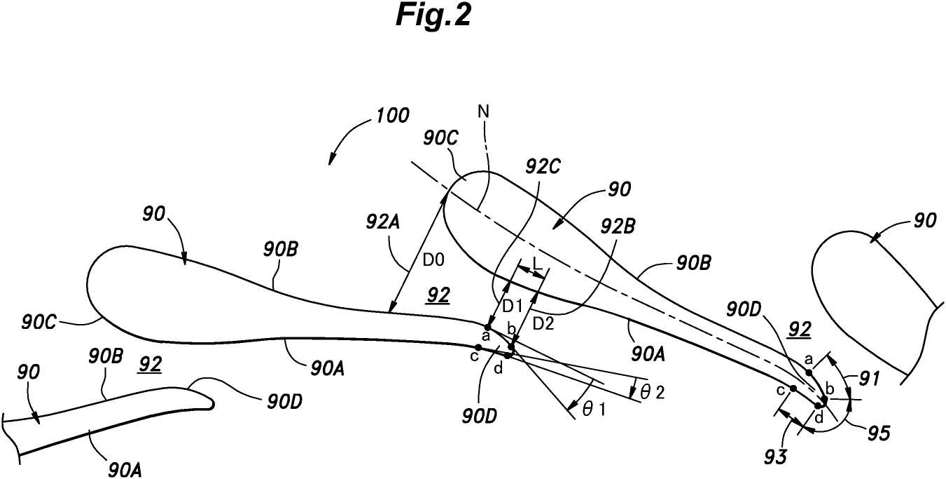

Next, details of the turbine nozzle device 100 will be described in the following with reference to FIG. 2.

The turbine nozzle device 100 is provided with a plurality of stator vanes 90 that are evenly spaced around the central axis of the turbine rotor 80 (see FIG. 1). The stator vanes 90 are all identical in shape, and each have a dorsal surface 90A facing radially inward and a ventral surface 90B facing away from the dorsal surface 90A (radially outward). Between the adjoining stator vanes 90 are defined flow paths 92 through which combustion gas (medium) flows in one direction. More specifically, each flow path 92 is defined between a leading edge part 90C of the stator vane 90 whose dorsal surface 90A opposes the flow path 92 and a trailing edge part 90D of the adjoining stator vane whose ventral surface 90B opposes the flow path 92.

The upstream end or the inlet 92A of each flow path 92 substantially coincides with the leading edge of the corresponding stator vane 90 (whose dorsal surface defines the corresponding flow path 92), and the downstream end or the outlet 92B of the flow path 92 substantially coincides with the trailing edge of the adjacent (opposing) stator vane 90 (whose ventral surface defines the corresponding flow path 92). Each flow path 92 progressively narrows from the inlet 92A thereof, and has a narrowest point or a throat 92C at some distance from the inlet 92A. The dorsal surface 90A and the ventral surface 90B are generally convex but are locally concave in the intermediate parts thereof. The dorsal surface 90A may be considered as a negative pressure surface, and the ventral surface 90B as a positive pressure surface.

The throat 92C is determined by measuring the distance between the adjoining stator vanes 90 along a normal line of each point on the ventral surface 90B and finding the point on the ventral surface 90B at which the distance is the smallest. The width of the flow path 92 between the adjacent stator vanes 90 or the blade to blade distance is defined as the distance therebetween as measured along a line parallel to the normal line at the throat 92C.

The width D0 of the flow path 92 at the upstream end or the inlet 92A is greater than the width D1 at the throat 92C, and the part of the ventral surface 90B extending from the inlet 92A to the throat 92C is substantially planar whereas the dorsal surface 90A extending over the same range is generally convex, the curvature progressively decreasing from the inlet 92A to the throat 92C. Therefore, the width or the cross sectional area of the flow path 92 defined between the stator vanes 90 progressively decreases from the inlet 92A to the throat 92C.

The ventral surface 90B of a trailing edge part 90D of the stator vane 90 includes a steeply inclined part 91 steeper as compared to the part of the ventral surface 90B upstream of the throat 92C. As a result, the flow path 92 progressively widens from the throat 92C to the outlet 92B. The steeply inclined part 91 is formed as a convex curved surface extending between the throat 92C (or a point adjacent thereto) to point b adjacent to the trailing edge of the stator vane 90, and smoothly continues from the part of the ventral surface 90B upstream of the throat 92C. The angle of the ventral surface 90B changes sharply near point a along the flow path. The angle change of the steeply inclined part 91 (along the length of the flow path 92) is significantly larger than the angle change of the part of the ventral surface 90B upstream of the throat 92C. The angle θ1 between the tangent line at point a, which is the start point of the steeply inclined part 91, and the tangent line at point b, which is the end point of the steeply inclined part 91, may be about 10 to 30 degrees.

Therefore, the width D2 at point b, which is the end point of the steeply inclined part 91, is larger than the width D1 at the throat 92C, and the relationship D0 > D2 > D1 holds. As a result, the flow path 92 demonstrates the maximum cross sectional area at the inlet 92A of the flow path 92 where the width D0 is the greatest, and the minimum cross sectional area at the throat 92C. The cross sectional area of the flow path 92 rapidly increases from the throat 92C to the outlet 92B. As a result, the flow paths forms a Laval nozzle.

Thus, the medium (combustion gas) flowing through the flow path 92 is compressed in the region extending from the inlet 92A to the throat 92C and expanded in the region extending from the throat 92C to the outlet 92B, thereby increasing the flow velocity of the combustion gas flowing into the turbine rotor 80 beyond the speed of sound (supersonic speed). As a result, the thermal efficiency of the radial turbine 16 is improved, and the fuel efficiency of the radial turbine 16 is improved.

By setting the angle θ1 formed by the tangent line at point a, which is the start point of the steeply inclined part 91, and the tangent line at point b, which is the end point of the steeply inclined part 91, to about 10 to 30 degrees, separation of the combustion gas flow and generation of an excessive shock wave can be avoided.

The downstream end part of the dorsal surface 90A on the back side or the opposite side of the steeply inclined part 91 is formed as an opposite inclined part 93 which is inclined in the same direction as the steeply inclined part 91 (with respect to the central line N of the stator vane which will be discussed later). The opposite inclined part 93 is formed as a substantially planar surface or a slightly concave surface extending between point c at which the normal line passing through point a intersects the dorsal surface 90A and point d adjacent to the trailing edge of the stator vane 90. An angle θ2 formed by a tangent line at point c, which is the start point of the opposite inclined part 93, and a tangent line at point d, which is the end point of the opposite inclined part 93, may be generally in the range of 0 to 10 degrees.

Since the opposite inclined part 93 is provided on the dorsal surface 90A opposite to the steeply inclined part 91, even though the steeply inclined part 91 is provided on the trailing end part of the ventral surface 90B of the stator vane 90, the thickness of the trailing edge part of the stator vane 90 (at the outlet 90B) is prevented from becoming excessively small (or in other words, an adequate thickness is ensured). As a result, even though the steeply inclined part 91 is provided on the ventral surfaces 90B of the stator vanes 90, the required mechanical strength of the stator vane 90 is ensured.

Points b and d near the trailing edge of the stator vane 90 are connected to each other by a connecting curved surface 95 which may be substantially arcuate. As a result, the trailing edge of the stator vane 90 is prevented from becoming excessively thin and sharp.

Line N in FIG. 2 is a line formed by equidistant points between the dorsal surface 90A and the ventral surface 90B of the stator vane 90 as measured along the normal lines of the respective surfaces. Due to the presence of the steeply inclined part 91 and the opposite inclined part 93, line N curves relatively sharply so as to widen the part of the flow path 92 extending from the throat 92C to the outlet 92B.

Assuming that the cross sectional area of the throat 92C is A1 and the cross sectional area of the outlet 92B is A2, the theoretical relationship between the Mach number M at the outlet 92B and the area ratio A2/A1 is as follows:

$$\begin{matrix}\text{A2} / \text{A1} = \left(1 / \text{M}\right) {\left[\left\{\left(\text{γ−1}\right) {\text{M}}^{2} + 2\right\} / \left(\text{γ+1}\right)\right]}^{\text{i}} \\ \text{i} \text{=} \left(\text{γ} \text{+} \text{1}\right) / \left\{2 \left(\text{γ} - 1\right)\right\}\end{matrix}$$

where γ is specific heat ratio.

As discussed above, the relationship between the Mach number M at the nozzle outlet and the area ratio A2/A1 is known, but there is no prior discussion regarding the provision of the steeply inclined part 91, let alone the optimum selection of the distance L between the throat 92C (point a) and the end point (point b) of the steeply inclined part 91.

In the turbine nozzle device 100 of the present embodiment, the width D1 at the throat 92C, and the distance between the throat 92C and the end point (point b) of the steeply inclined part 91 are related to one another such that

$$1 ≦ \left(\text{D} 1 / \text{L}\right) ≦ 4.$$

When 1 > (D1/L) or when the distance L is greater than the width D1 at the throat 92C the supersonic region along the flow direction of the combustion gas flowing through the flow path 92 extends such a long distance that the pressure loss undesirably increases. When 4 < (D1/L), the flow path on the downstream side of the throat 92C becomes so short that the width D2 cannot be adequately increased so that the flow velocity of the combustion gas at the nozzle outlet cannot be accelerated to a supersonic speed. In other words, when 4 < (D1/L), the length of the flow path downstream of the throat 92C in the flow direction (distance L) is insufficient for the necessary expansion ratio of the cross-sectional area of the flow path from the throat 92C to the outlet 92B to be achieved. If the flow velocity is increased, the cross-sectional area of the flow path from the throat 92C to the outlet 92B increases so rapidly that excessive flow separation is likely to occur and undesired shock wave may be created. This in turn causes an unacceptable pressure loss.

When the distance L between the throat 92C and the end point (point b) of the steeply inclined part 91 satisfies the relationship of 1 ≦ (D1/L) ≦4, the combustion gas flowing through the flow path 92 is enabled to flow the flow path without experiencing any undue pressure loss, and the flow velocity of the combustion gas at the outlet of the flow path 92 can exceed the speed of sound. As a result, the use of the turbine nozzle device 100 according to the present embodiment improves the thermal efficiency of the radial turbine 16 and the fuel efficiency of the radial turbine 16.

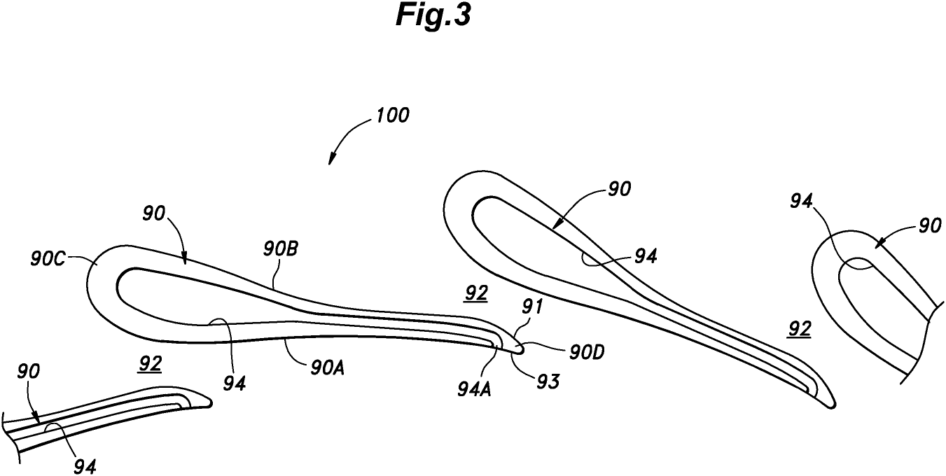

A modification of the turbine nozzle device 100 of the first embodiment will be described in the following with reference to FIG. 3. The parts corresponding to those shown in FIG. 2 are denoted with like reference numerals as those in FIG. 2, and description of such part may be omitted in the following discussion.

In this modified embodiment, each stator vane 90 is provided with an internal cooling passage 94 extending along the chord of the stator vane 90 as well as along the length of the stator vane 90. The cooling passage 94 extends from the vicinity of the leading edge part 90C of the stator vane 90 to the vicinity of the tip of the trailing edge part 90D. The cooling passage 94 is closed at the leading edge part 90C, but communicates with the outside at the trailing edge part 90D via a cooling medium outlet 94A opening on the dorsal surface 90A near the trailing edge. Cooling air serving as a cooling medium is supplied to the cooling passage 94 from the base end side thereof, and the cooling passage 94 is closed at the free end side thereof. The cooling medium outlet 94A may be a slit extending along the length of the stator vane 90 from the base end to the free end thereof, or may also be formed by a plurality of openings arranged along the length of the stator vane 90.

The cooling air cools the stator vane 90 while flowing through the cooling passage 94, and is discharged to the outside from the cooling medium outlet 94A. As a result, the temperature rise of the stator vanes 90 can be suppressed, and the temperature of the combustion gas flowing through the flow path 92 can be increased so that the performance of the gas turbine power generator system 10 for power generation can be improved.

Since the cooling medium outlet 94A opens on the dorsal surface 90A of the stator vane 90, adverse effect of discharging the cooling medium on the combustion gas flowing through the flow path 92 is minimized as compared to the case where the cooling medium outlet 94A opens on the ventral surface 90B of the stator vane 90.

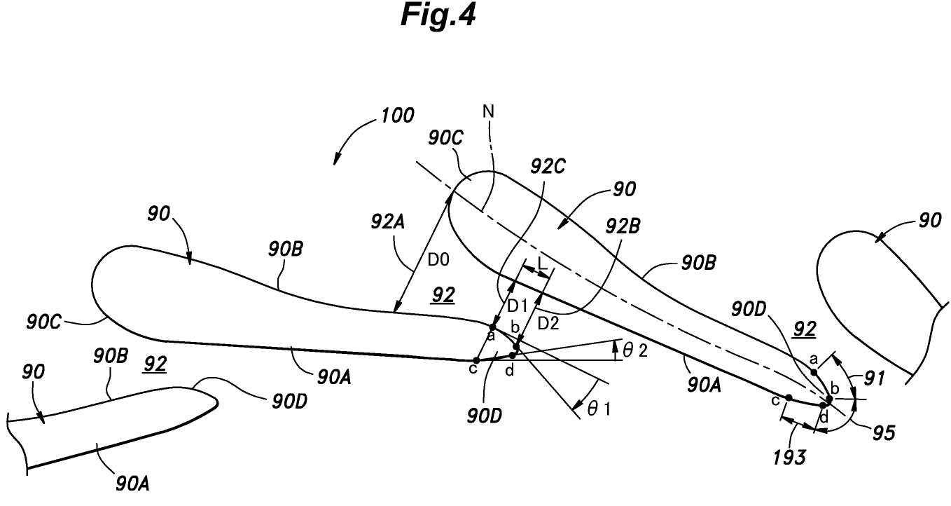

Next, a turbine nozzle device 100 according to a second embodiment of the present invention will be described in the following with reference to FIG. 4, in which the parts corresponding to those in FIG. 2 are denoted with like reference numerals as those in FIG. 2, and description of such parts may be omitted in the following discussion.

The dorsal surface 90A of each stator vane 90 of the present embodiment is provided with an opposite inclined part 193 which is positioned on the opposite side of the steeply inclined part 91 or at a trailing edge part of the dorsal surface 90A. As opposed to the opposite inclined part 193 of the first embodiment, this opposite inclined part 193 is inclined in the opposite direction to the steeply inclined part 91. In this case also, the opposite inclined part 193 extends as a substantially planar or slightly concave surface between point c at which the normal line passing through point a intersects the dorsal surface 90A and point d adjacent to the trailing edge of the stator vane 90. Thus, the opposite inclined part 193 of this embodiment differs from the opposite inclined part 193 of the first embodiment in that the inclination angle thereof relative to the steeply inclined part 91 is opposite from that of the first embodiment. Thus, the opposite inclined part 193 of this embodiment (FIG. 4) inclines in the opposite direction to the steeply inclined part 91 whereas the opposite inclined part 193 of the first embodiment inclines in the same direction as the steeply inclined part 91 (FIG. 2).

In this case, the angle θ2 between the tangent line at point c, which is the start point of the opposite inclined part 193, and the tangent line at point d, which is the end point of the opposite inclined part 193, may be — 5 to 0 degrees. Thereby, in spite of the presence of the steeply inclined part 91 in the trailing edge part of the ventral surface 90B of the stator vane 90, the stator vane 90 is prevented from being excessively thick at the part thereof adjacent to the throat 92C and the part upstream of the throat 92C. An angle θ2 formed by a tangent line at point c, which is the start point of the opposite inclined part 93, and a tangent line at point d, which is the end point of the opposite inclined part 93, may be generally in the range of -5 to 10 degrees.

Points b and d adjacent to the trailing edge of stator vane 90 are connected to each other by a connecting curved surface 95 consisting of a substantially arcuate surface, so that the tip of the trailing edge of the stator vane 90 is prevented from becoming excessively thin and sharp similarly as in the first embodiment shown in FIG. 2.

It should be noted that the modification illustrated in FIG. 3 is equally applicable to the second embodiment.

The present invention has been described in terms of specific embodiments, but the present invention is not limited by such embodiments and can be modified in various ways without departing from the scope of the present invention. Moreover, not all of the constituent elements shown in the above embodiments are essential to the broad concept of the present invention, and they can be appropriately selected, omitted and substituted without departing from the gist of the present invention.

For example, point a, or the start point of the steeply inclined part 91, does not necessarily have to be provided at a position coinciding with the throat 92C, but may also be set slightly downstream of the throat 92C. The turbine nozzle device 100 can be applied not only to the radial turbine 16 of a gas turbine power generator system 10 but also to various industrial turbines, aircraft turbines, and the like. The turbine nozzle device 100 may also be applied to axial flow turbines. The contents of any cited references in this disclosure will be incorporated in the present application by reference.

1. A turbine nozzle device including a plurality of stator vanes, a flow path being defined between a leading edge part of each stator vane and a trailing edge part of the adjoining stator vane,
wherein the flow path includes an inlet, an outlet and a throat located between the inlet and the outlet and narrower than the inlet and the outlet, and
a surface of the trailing edge part of each stator vane that faces the flow path includes a steeply inclined part which is located downstream of the throat and more steeply inclined than a part of the surface upstream of the throat so as to form a widening part of the flow path extending from the throat or a point adjacent to the throat to the outlet.

2. The turbine nozzle device according to claim 1, wherein an angle (θ1) formed by a tangent line at a start point of the steeply inclined part and a tangent line at an end point of the steeply inclined part is 10 to 30 degrees.

3. The turbine nozzle device according to claim 1, wherein the steeply inclined part has a length related to a width of the flow path at the throat as given by 1 ≦ (D1/L) ≦ 4, where D1 is the width of the flow path at the throat, and L is the length of the steeply inclined part.

4. The turbine nozzle device according to claim 1, wherein a surface of the trailing edge part facing away from the steeply inclined part includes an opposite inclined part which is inclined in a same direction as the steeply inclined part.

5. The turbine nozzle device according to claim 4, wherein an angle (θ2) formed by a tangent line at a start point of the opposite inclined part and a tangent line at an end point of the opposite inclined part is 0 to 10 degrees.

6. The turbine nozzle device according to claim 1, wherein a surface of the trailing edge part facing away from the steeply inclined part includes an opposite inclined part which is inclined in an opposite direction to the steeply inclined part.

7. The turbine nozzle device according to claim 6, wherein an angle (θ2) formed by a tangent line at a start point of the opposite inclined part and a tangent line at an end point of the opposite inclined part is from ― 5 to 0 degrees.

8. The turbine nozzle device according to claim 1, wherein each stator vane is internally provided with a cooling passage extending along the flow path and a lengthwise direction of the stator vane.
